(19) United States
(12) Patent Application Publication
(10) Pub. No.: US 2005/0150766 A1
(43) Pub. Date: Jul. 14, 2005

(54) Capillary electrophoresis microchip system and method

(76) Inventors: Andreas Manz, Dortmund (DE); Chao-Xuan Zhang, Salt Lake City, UT (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/494,134

(22) PCT Filed: Nov. 2, 2001
(86) PCT No.: PCT/GB01/04853

(51) Int. Cl. G01N 27/453

(52) U.S. Cl. 204/452; 204/601

(57) ABSTRACT

A capillary electrophoresis microchip (1) including at least one capillary electrophoresis separation unit (3), a capillary electrophoresis system incorporating the same, and a capillary electrophoresis separation method, each separation unit comprising: a separation channel (5) in which analytes of a sample plug are in use separated, wherein the separation channel has a first width; and a sample channel (9) fluidly connected to the separation channel through which a sample plug is in use introduced into the separation channel, wherein the sample channel has a second width which is smaller than the first width of the separation channel at least at intersection of the sample channel (9) and the separation channel (5).

The present invention relates to a capillary electrophoresis (CE) microchip, a measurement system incorporating the same and a related separation method.

CE microchips have been developed for the analysis of various substances, ranging from small drug molecules [1], amino acids [2], peptides [3] and oligonucleotides [4] to large proteins [5] and DNA fragments [6].

In CE microchips, sample injection is achieved through a channel network, that is, a sample channel which intersects a separation channel. The first CE microchips employed a tee injector configuration [7, 8]. However, control of the sample plug proved difficult with such a configuration, and, as a consequence, such an injector has rarely been pursued [9]. CE microchips were then developed having a cross or double-tee injector configuration [10, 11].

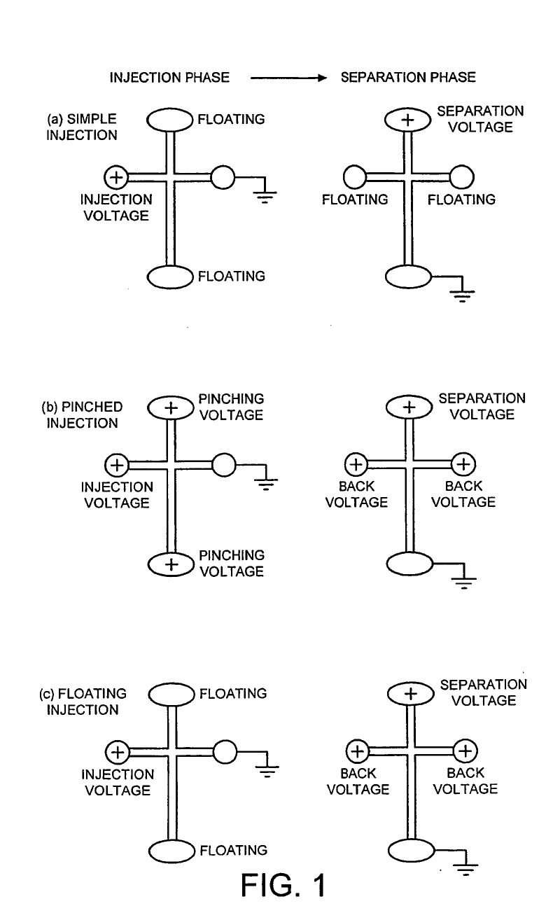

In CE microchips using cross or double-tee injectors, two run phases are usually involved, these being injection and separation phases, as illustrated in FIG. 1. In the injection phase, sample is drawn from a sample reservoir across the injection intersection towards a sample waste reservoir by applying an electric field along the sample channel, thereby developing an analyte stream perpendicular to the separation channel. In the separation phase, an electric field is applied along the separation channel to drive a sample plug from the injection intersection through the separation channel for detection.

Early CE measurement systems utilized a simple injection scheme [10, 11], as illustrated in FIG. 1(a). It was, however, soon realized that control of the voltage of all of the device ports in both the injection and separation phases was necessary in order to inject a short, well-defined sample plug into the separation channel, and thereby provide for high separation efficiency [12-14].

Thus, a pinched injection scheme was developed, as illustrated in FIG. 1(b); this injection scheme now being commonly adopted in CE measurement systems [1, 6, 15-20]. In the pinched injection scheme, pinching voltages are applied at the buffer inlet and the buffer outlet during the sample injection phase in order to induce flows of buffer solution towards the sample waste reservoir and thereby counteract the diffusion of analytes into the separation channel, and back voltages are applied to the sample reservoir and the sample waste reservoir during the separation phase in order to draw the analyte flows back into the respective ones of the sample reservoir and sample waste reservoir and thereby prevent leakage into the separation channel. The pinched injection scheme does, however, have the particular drawback of requiring long injection times, typically between 10 and 150 s, for the migration of the analytes from the sample reservoir to the injection intersection. The injection time is comparable or even longer than the real analytical time, thereby restricting the analytical speed.

A floating injection scheme has also been developed, as illustrated in FIG. 1(c). In the floating injection scheme, back voltages are applied to the sample reservoir and the sample waste reservoir during the separation phase in order to draw the analyte flows back into the respective ones of the sample reservoir and the sample waste reservoir and thereby prevent leakage into the separation channel.

A gated injection scheme has further been developed for providing for the fast injection of analytes to the injection intersection [5, 21-23]. In contrast to the pinched injection scheme, the analyte stream makes a 90 degree turn at the injection intersection towards the sample waste reservoir. In the separation phase, analytes are continuously driven through the injection intersection, with buffer solution being electroosmotically pumped towards the sample waste reservoir and the buffer waste reservoir in order to prevent leakage into the separation channel. For injection, the analyte flow is deflected into the separation channel for a short period of time, typically between 0.1 and 0.5 s. Where multiple injections are performed, the subsequent sample is transported to the injection intersection while the current separation is underway, thereby readying the subsequent sample for injection. With this configuration, virtually no time is required for the injection phase.

Whilst operative, all of the above-described injection schemes necessarily require voltage protocols in order to effect leakage control. Furthermore, the involved relationships between microchip geometry, operating conditions and fluidic behaviour add to the complexity of both the hardware and the software of the systems.

It is thus an aim of the present invention to provide an improved CE microchip, CE measurement system, and CE separation method.

Accordingly, the present invention provides a capillary electrophoresis microchip including at least one capillary electrophoresis separation unit, each separation unit comprising: a separation channel in which analytes of a sample plug are in use separated, wherein the separation channel has a first width; and a sample channel fluidly connected to the separation channel through which a sample plug is in use introduced into the separation channel, wherein the sample channel has a second width which is smaller, preferably substantially smaller, than the first width of the separation channel at least at intersection of the sample channel and the separation channel.

Preferably, the ratio of the first width to the second width is at least about 2:1.

More preferably, the ratio of the first width to the second width is at least about 5:1.

Still more preferably, the ratio of the first width to the second width is at least about 10:1.

Preferably, the second width is not more than about 10 μm.

More preferably, the second width is not more than about 5 μm.

Preferably, the separation channel and the sample channel have the same depth.

Preferably, the sample channel intersects the separation channel in a direction substantially perpendicular to the separation channel.

In one embodiment the sample channel comprises a single sample channel fluidly connected to the separation channel, whereby the separation channel and the sample inlet channel define a tee injector.

In another embodiment the sample channel comprises a sample inlet channel fluidly connected to one side of the separation channel and a sample outlet channel fluidly connected to the other side of the separation channel, whereby the separation channel and sample channels define a cross injector.

Preferably, the sample inlet channel and the sample outlet channel are disposed in opposed relation.

Preferably, the microchip comprises a plurality of separation units.

More preferably, the microchip further comprises: a buffer supply reservoir to which inlet ends of the separation channels of the separation units are commonly connected; and a buffer waste reservoir to which outlet ends of the separation channels of the separation units are commonly connected.

In one embodiment the separation channel has a uniform width.

In another embodiment the sample channel has a uniform width.

The present invention also extends to a capillary electrophoresis measurement system incorporating the above-described microchip.

The present invention also provides a method of separating analytes of a sample plug, comprising the steps of: providing a capillary electrophoresis microchip including at least one capillary electrophoresis separation unit, wherein each separation unit comprises a separation channel having a first width, one end of which provides an inlet through which a buffer medium is introduced and the other end of which provides an outlet through which a buffer medium is exhausted, a sample reservoir containing a sample, and a sample channel fluidly connecting the sample reservoir and the separation channel through which a sample plug is introduced into the separation channel, the sample channel having a second width which is smaller, preferably substantially smaller, than the first width of the separation channel at least at intersection of the sample channel and the separation channel; injecting a sample plug into the separation channel by employing a first voltage protocol; and separating analytes of the sample plug in the separation channel by employing a second voltage protocol.

In one embodiment the step of injecting a sample plug into the separation channel comprises the step of applying only a single injection voltage.

Preferably, the single injection voltage is applied to the sample reservoir.

In one embodiment the step of separating analytes of the sample plug in the separation channel comprises the step of applying only a single separation voltage.

Preferably, the single separation voltage is applied to the inlet end of the separation channel.

In one embodiment the sample channel comprises a single sample channel fluidly connected to the separation channel, whereby the separation channel and the sample channel define a tee injector.

In one embodiment the step of injecting a sample plug into the separation channel comprises the step of applying a potential between the sample reservoir and the inlet end of the separation channel, and leaving the outlet end of the separation channel floating.

In another embodiment the step of injecting a sample plug into the separation channel comprises the step of applying only a single injection voltage to the sample reservoir.

In a further embodiment the step of injecting a sample plug into the separation channel comprises the step of applying only a single injection voltage to the inlet end of the separation channel.

In a yet further embodiment the step of injecting a sample plug into the separation channel comprises the step of applying an injection voltage to the sample reservoir, grounding the inlet end of the separation channel, and leaving the outlet end of the separation channel floating.

In a still yet further embodiment the step of injecting a sample plug into the separation channel comprises the step of applying an injection voltage to the inlet end of the separation channel, grounding the sample reservoir, and leaving the outlet end of the separation channel floating.

In one embodiment the step of separating analytes of the sample plug in the separation channel comprises the step of applying a potential between the inlet and outlet ends of the separation channel, and leaving the sample reservoir floating.

In another embodiment the step of separating analytes of the sample plug in the separation channel comprises the step of applying only a single separation voltage to the inlet end of the separation channel.

In a further embodiment the step of separating analytes of the sample plug in the separation channel comprises the step of applying only a single separation voltage to the outlet end of the separation channel.

In a yet further embodiment the step of separating analytes of the sample plug in the separation channel comprises the step of applying a separation voltage to the inlet end of the separation channel, grounding the outlet end of the separation channel, and leaving the sample reservoir floating.

In a still yet further embodiment the step of separating analytes of the sample plug in the separation channel comprises the step of applying a separation voltage to the outlet end of the separation channel, grounding the inlet end of the separation channel, and leaving the sample reservoir floating.

In another embodiment the sample channel comprises a sample inlet channel fluidly connected to the sample reservoir and one side of the separation channel and a sample outlet channel fluidly connected to the other side of the separation channel, whereby the separation channel and the sample channels define a cross injector, and each separation unit further comprises a sample waste reservoir fluidly connected to the sample outlet channel.

Preferably, the sample inlet channel and the sample outlet channel are disposed in opposed relation.

In one embodiment the step of injecting a sample plug into the separation channel comprises the step of applying a potential between the sample reservoir and the sample waste reservoir, and leaving the inlet and outlet ends of the separation channel floating.

In another embodiment the step of injecting a sample plug into the separation channel comprises the step of applying only a single injection voltage to the sample reservoir.

In a further embodiment the step of injecting a sample plug into the separation channel comprises the step of applying only a single injection voltage to the sample waste reservoir.

In a yet further embodiment the step of injecting a sample plug into the separation channel comprises the step of applying an injection voltage to the sample reservoir, grounding the sample waste reservoir, and leaving the inlet and outlet ends of the separation channel floating.

In a still yet further embodiment the step of injecting a sample plug into the separation channel comprises the step of applying an injection voltage to the sample waste reservoir, grounding the sample reservoir, and leaving the inlet and outlet ends of the separation channel floating.

In one embodiment the step of separating analytes of the sample plug in the separation channel comprises the step of applying a potential between the inlet and outlet ends of the separation channel, and leaving the sample reservoir and the sample waste reservoir floating.

In another embodiment the step of separating analytes of the sample plug in the separation channel comprises the step of applying only a single separation voltage to the inlet end of the separation channel.

In a further embodiment the step of separating analytes of the sample plug in the separation channel comprises the step of applying only a single separation voltage to the outlet end of the separation channel.

In a yet further embodiment the step of separating analytes of the sample plug in the separation channel comprises the step of applying a separation voltage to the inlet end of the separation channel, grounding the outlet end of the separation channel, and leaving the sample reservoir and sample waste reservoir floating.

In a still yet further embodiment the step of separating analytes of the sample plug in the separation channel comprises the step of applying a separation voltage to the outlet end of the separation channel, grounding the inlet end of the separation channel, and leaving the sample reservoir and sample waste reservoir floating.

Preferably, the ratio of the first width to the second width is at least about 2:1.

More preferably, the ratio of the first width to the second width is at least about 5:1.

Still more preferably, the ratio of the first width to the second width is at least about 10:1.

Preferably, the second width is not more than about 10 μm.

More preferably, the second width is not more than about 5 μm.

Preferably, the separation channel and the sample channel have the same depth.

Preferably, the sample channel intersects the separation channel in a direction substantially perpendicular to the separation channel.

Preferably, the microchip comprises a plurality of separation units, whereby the method provides for the simultaneous measurement of a plurality of sample plugs.

More preferably, the microchip further includes a buffer supply reservoir to which inlet ends of the separation channels of the separation units are commonly connected, and a buffer waste reservoir to which outlet ends of the separation channels of the separation units are commonly connected.

In one embodiment the separation channel has a uniform width.

In another embodiment the sample channel has a uniform width.

With this configuration, where the sample channel has a smaller width, preferably a substantially smaller width, than the separation channel at least at intersection of the sample channel and the separation channel, the CE microchip of the present invention provides for improved resolution and sensitivity as compared to known CE microchips, which microchips all have sample channels and separation channels of the same width at least at the injection intersections. The effect of the configuration of the present invention is quite surprising, and indeed counter-intuitive, since greater relative diffusion of a sample plug would be expected for sample channels of smaller width.

Moreover, the CE microchip of the present invention is such as to provide a CE measurement system which does not require any voltage control to prevent leakage, thereby greatly simplifying the required voltage protocol.

Furthermore, the CE microchip of the present invention, where incorporating a tee injector, provides a resolution which cannot be obtained with any of the known tee injector configurations.

Yet furthermore, with such a tee injector configuration, the CE microchip of the present invention is also such as to advantageously provide a multiplexed CE measurement system which requires a much reduced number of reservoirs. The present invention provides a system which requires only N+2 reservoirs, where N is the number of parallel CE separation units in the system. Previously, a multiplexed CE measurement system comprising 2N+1 reservoirs had been achieved [6], and a minimum of N+3 predicted [24].

The narrow sample channel injectors of the present invention are to be known as the NSC™ injectors.

Preferred embodiments of the present invention will now be described hereinbelow by way of example only with reference to the accompanying drawings, in which:

FIG. 1(a) illustrates the injection and separation phases of the simple injection scheme;

FIG. 1(b) illustrates the injection and separation phases of the pinched injection scheme;

FIG. 1(c) illustrates the injection and separation phases of the floating injection scheme;

FIG. 2 schematically illustrates a CE measurement system incorporating a CE microchip in accordance with a first embodiment of the present invention;

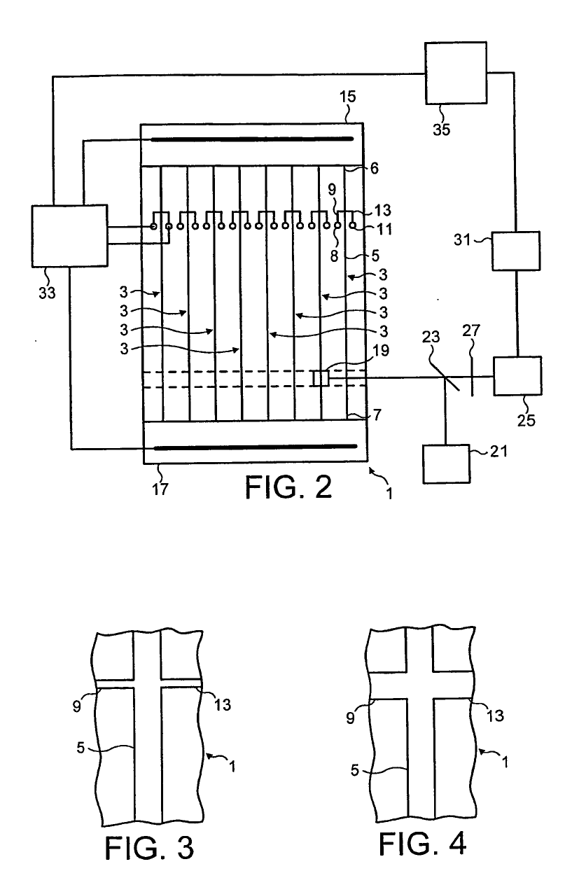

FIG. 3 illustrates in enlarged scale the injection intersection of the microchip of FIG. 2;

FIG. 4 illustrates the injection intersection of a cross injector of a conventional CE microchip;

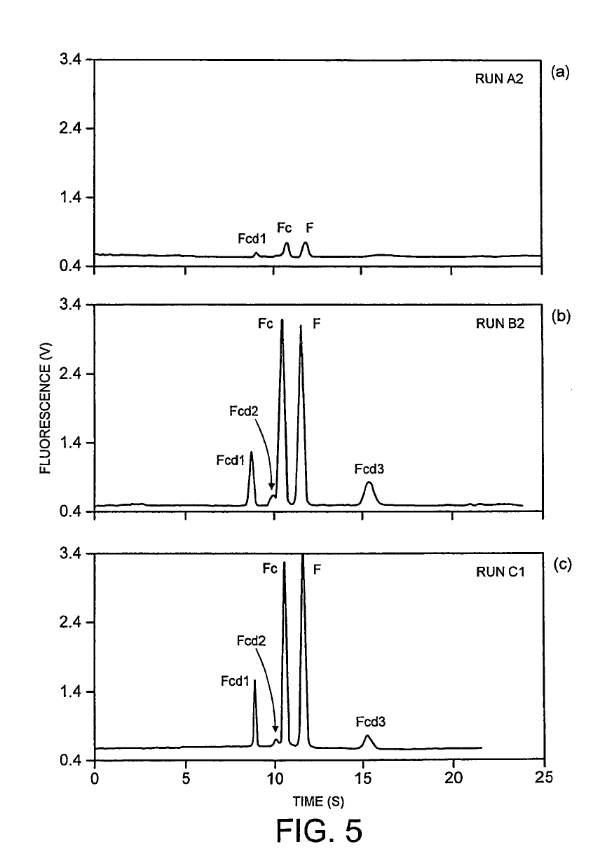

FIGS. 5(a) to (c) illustrate electropherograms obtained from runs, Runs A2, B2 and C1 respectively, in the described Example utilizing the measurement system of FIG. 2;

FIG. 6 schematically illustrates a CE measurement system incorporating a CE microchip in accordance with a second embodiment of the present invention;

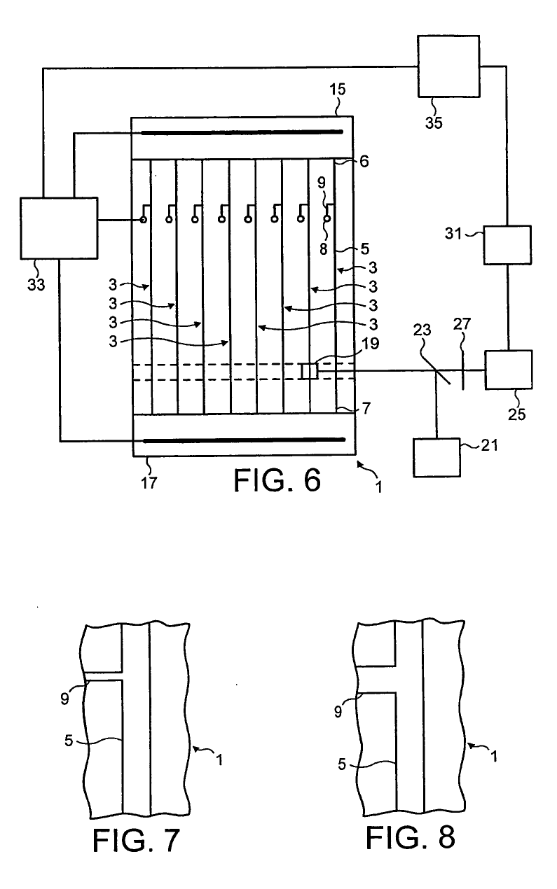

FIG. 7 illustrates in enlarged scale the injection intersection of the microchip of FIG. 6;

FIG. 8 illustrates the injection intersection of a tee injector of a conventional CE microchip; and

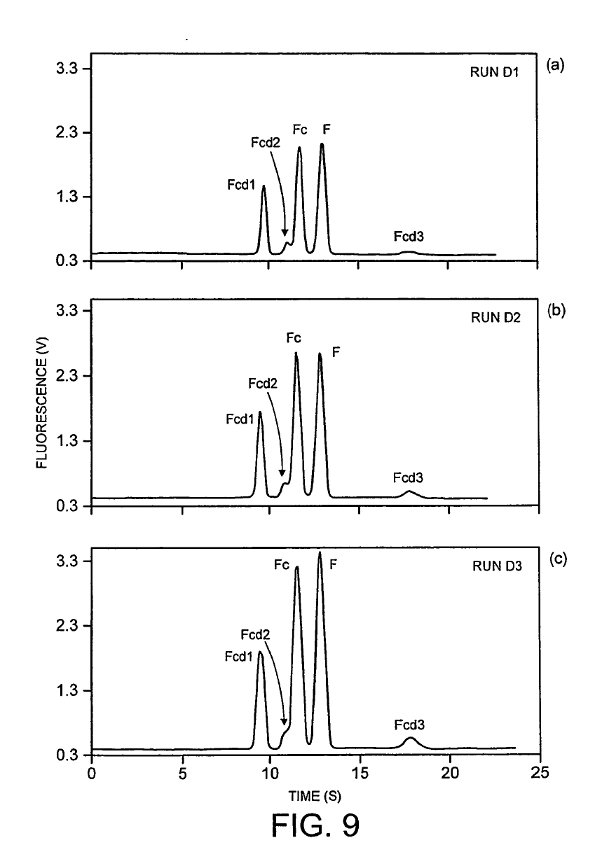

FIGS. 9(a) to (c) illustrate electropherograms obtained from runs, Runs D1, D2 and D3 respectively, in the described Example utilizing the measurement system of FIG. 6.

FIG. 2 illustrates a CE measurement system in accordance with a first embodiment of the present invention.

The measurement system comprises a CE microchip 1 which includes at least one CE separation unit 3, in this embodiment a plurality of multiplexed separation units 3 disposed in parallel relation. For the purposes of exemplification, the microchip 1 is illustrated as including eight separation units 3, but could comprise any number of separation units 3, from one to many hundreds.

Each separation unit 3 includes a separation channel 5, in this embodiment an elongate linear channel having a length of 33 mm, a width of 50 μm and a depth of 10 μm, one end 6 of which provides as an inlet through which a buffer medium is introduced and the other end 7 of which provides an outlet through which the buffer medium is exhausted. In operation, a sample plug is injected into the separation channel 5 and the analytes of the sample plug are separated during migration through the separation channel 5 as will be described in more detail hereinbelow.

Each separation unit 3 further includes a sample reservoir 8, in this embodiment a cavity having a diameter of 1 mm, into which a volume of a sample liquid is introduced, a sample inlet channel 9, in this embodiment having a length of 9 mm, a width of 10 μm and a depth of 10 μm, which fluidly connects the sample reservoir 8 to the separation channel 5, a sample waste reservoir 11, in this embodiment a cavity having a diameter of 1 mm, which receives waste sample liquid, and a sample outlet channel 13, in this embodiment having a length of 9 mm, a width of 10 μm and a depth of 10 μm, which fluidly connects the sample waste reservoir 11 to the separation channel 5. In this embodiment the sample channels 9, 13 are disposed in opposed relation and intersect the separation channel 5 in a direction perpendicular thereto, such that the separation channel 5 and the sample channels 9, 13 define a cross injector. In this embodiment the sample channels 9, 13 intersect the separation channel 5 at a distance of 3 mm from the inlet end 6 thereof and 30 mm from the outlet end 7 thereof.

The microchip 1 further includes a common buffer supply reservoir 15 which is commonly connected to the inlet ends 6 of the separation channels 5 of each of the separation units 3, and a common buffer waste reservoir 17 which is commonly connected to the outlet ends 7 of the separation channels 5 of each of the separation units 3. In this embodiment the buffer reservoirs 15, 17 each have a length of 35 mm and a width of 7 mm.

The microchip 1 is fabricated from two planar plates, in this embodiment a plain glass substrate having a thickness of 1.5 mm and a poly (dimethylsiloxane) (PDMS) layer having a thickness about 0.3 to 0.4 mm. The fabrication of the PDMS layer, which defines the channels 5, 9, 13 and the reservoirs 8, 11, 15, 17 of the microchip 1, was performed in a number steps. In a first step, the chip layout was transferred onto a glass wafer having a coating of positive photoresist and chromium (Nanofilm, Westlake Village, Calif., US). In a second step, the chromium was etched to provide a chromium mask defining the chip layout. In a third step, a plain glass wafer was spin-coated with a negative photoresist (XP SU-8 10, MicroChem Corporation, Newton, Mass., US) at 2000 to 3000 rpm to provide an SU-8 master mask; the spinning speed determining the thickness of the coating and hence the depth of the wells which define the separation channels 5 and the sample channels 9, 13. In a fourth step, the transparent pattern on the chromium mask was then transferred to the master mask by disposing the chromium mask on the master mask and exposing the master mask using a collimated light beam, in this embodiment from a mercury lamp. In a fifth step, the unexposed SU-8 was flushed from the master mask with an SU-8 developer, leaving the SU-8 structures on the surface of the master mask. In a sixth step, PDMS base and curing agents (Sylgard 184, Dow Corning, Wiesbaden, Germany) were mixed in a 10:1 ratio and poured onto the master mask, and the resulting PDMS layer cured at 40° C. In a seventh step, large slots were cut into the PDMS layer at the respective ends of the wells defining the separation channels 5 to form openings which define the buffer reservoirs 15, 17. In an eighth step, sixteen holes were bored into the PDMS layer so as to provide the openings which define the sample reservoirs 8 and the sample waste reservoirs 11. In a final step, the PDMS layer and the glass substrate were assembled to form the microchip 1.

The measurement system further comprises a confocal detection unit for detecting the optical emission, in this embodiment the fluorescence emission, from a detection region, in this embodiment a 50 μm×50 μm detection region, located, in this embodiment 28 mm, downstream of the injection intersection in the separation channel 5 of each of the separation units 3. In this embodiment the detection unit is a scanning unit which scans a detection window overlying the detection regions in the separation channels 5. In this embodiment the microchip 1 is disposed on a computer-controlled translation stage, whereby scanning is achieved by translating the microchip 1.

The detection unit comprises an objective 19 for imaging respective ones of the detection regions, a light source 21, in this embodiment a 50 W mercury lamp (Leica, Milton Keynes, UK), for providing a light beam for illuminating respective ones of the detection regions, and a dichroic beam splitter 23 (RKP 510) for directing the light beam from the light source 21 to the objective 19 and providing for the transmission of the optical emission from the respective detection region.

The detection unit further comprises an optical detector 25, in this embodiment a photomultiplier tube (MEA 153, Seefelder Messtechnik, Seefelder, Germany), for detecting the optical emission from the respective ones of the detection regions, in this embodiment the fluorescence emission, and at least one filter 27, in this embodiment two band pass filters (BP 450-490 nm, 515-560 nm) disposed upstream of the optical detector 25. In an alternative embodiment the optical detector 25 could comprise a CCD color camera (Sony Corporation, Japan).

The measurement system further comprises a data acquisition unit 31 which is connected to the optical detector 25 for logging the output signal thereof.

The measurement system further comprises a power supply unit 33 for applying potentials at the electrodes in each of the sample reservoirs 8, the sample waste reservoirs 11, the buffer reservoir 15 and the buffer waste reservoir 17. For ease of illustration, FIG. 2 illustrates the power supply unit 33 connected to the sample reservoir 8 and the sample waste reservoir 11 of only one of the separation units 3. In this embodiment each electrode is connected to two power supplies (F.u.G. Elektronik GmbH, Roseheim, Germany) and one ground line through relays, thereby enabling two different voltages and ground potential to be applied to each electrode in any run. In this embodiment the electrodes in the buffer reservoirs 15, 17 comprise elongate, linear platinum wire electrodes. Platinum wire electrodes are utilized to minimize the generation of air bubbles by electrolysis at the surface of the electrodes [25]. Electrolysis at the electrode surfaces is particularly evident in multiplexed systems as the current is many times higher than in single-channel systems. The use of long linear electrodes also has the particular advantage of ensuring that the potential is the same at the same length points for each of the separation channels 5.

The measurement system further comprises a processing unit 35, in this embodiment a personal computer, for controlling the power supply unit 33 and operating on the acquired data. In this embodiment the data acquisition unit 31 and the power supply unit 33 are operated under the control of a Labview program (Version 5.0, National Instruments, Austin, Tex., US), with data being acquired at a rate of 50 points/s.

Operation of the above-described measurement system of the present invention will now be described with reference to the following non-limiting Example.

Reagents and Solutions

A running buffer solution was prepared from 50 mM each of Tris (hydroxymethyl) aminomethane (Tris) (Lancaster Synthesis, Morecambe, UK) and N-tris (hydroxymethyl) methyl-3-aminopropanesulfonic acid (TAPS) (Merck, Leics, UK) (pH 8.8).

A sample solution containing 1 μg/mL fluorescein and 5 μg/mL fluorescein-5-isothiocyanate was prepared from fluorescein (Fluka, Buchs, Germany) and fluorescein-5-isothiocyanate (FITC) (Merck, Darmstadt, Germany) with the running buffer solution.

Experimental

The microchip 1 was first filled with ethanol by filling the buffer supply reservoir 15 and allowing the separation channels 5 and the sample channels 9, 13 to fill by capillary action. The buffer reservoirs 15, 17 were then each flushed with de-ionized water and loaded with 1.5 mL of buffer solution. An electric field was then applied between the buffer reservoirs 15, 17 to fill the separation channels 5 by electroosmotic flow. The separation units 3 were then ready for CE separation.

In ones of the separation units 3, 3 μL aliquots of sample solution and buffer solution were introduced, in this embodiment by pipetting, into the respective ones of the sample reservoirs 8 and the sample waste reservoirs 11. CE separation runs (Runs A to C) utilizing the pinched, floating and simple injection schemes were then performed.

Results

The results of the measurements are given in Table 1 hereinbelow.

TABLE 1
Injection Schemes for Cross Injector Configurations

| | | tᵢₙⱼ | | Lᵢₙⱼ^{b} | W_{1/2}^{c} | N^{c} | | Hₚₗₐₜₑ^{c} |
|---|---|---|---|---|---|---|---|---|
| Cross Injector | Injection Run | (s) | S/N^{a} | (μm) | (μm) | (K) | R^{d} | (μm) |
| Conventional | Pinched | 20 | 10 | 110 | 757 | 7.59 | 1.68 | 3.69 |
| | | 40 | 12 | 110 | 746 | 7.81 | 1.75 | 3.59 |
| | Floating | 15 | 56 | 190 | 875 | 5.68 | 1.55 | 4.93 |
| | | 20 | 80 | 310 | 1018 | 4.19 | 1.36 | 6.69 |
| Inventive | Run A1 (Pinched) | 20 | 8 | 60 | 758 | 7.56 | 1.80 | 3.70 |
| | Run A2 (Pinched) | 40 | 9 | 60 | 759 | 7.55 | 1.73 | 3.71 |
| | Run B1 (Floating) | 15 | 76 | 150 | 680 | 9.40 | 2.03 | 2.98 |
| | Run B2 (Floating) | 20 | 104 | 220 | 755 | 7.62 | 1.84 | 3.68 |
| | Run C1 (Simple) | 0.5 | 108 | | 522 | 15.96 | 2.46 | 1.75 |
| | Run C2 (Simple) | 2 | 140 | | 574 | 13.16 | 2.29 | 2.13 |
| | Run C3 (Simple) | 3 | 164 | | 687 | 9.20 | 1.87 | 3.04 |

^{a}The signal-to-noise ratio as calculated based on the peak height of 1 μg/mL fluorescein.
^{b}The injected sample plug length (Lᵢₙⱼ) was measured by eye-checking the fluorescence images around the injection intersection with a sample solution containing 5 μg/mL fluorescein.
^{c}The peak width at half peak height (W_{1/2}), theoretical plate number (N) and plate height (Hₚₗₐₜₑ) are for FITC.
^{d}R is the resolution between FITC and fluorescein.

Run A1

A sample plug was injected into a first separation channel 5 and the analytes therein separated in the separation channel 5. In the injection phase, the injection time was 20 s, and a voltage of 1.08 kV was applied to the electrode in the sample reservoir 8, the electrode in the sample waste reservoir 11 was grounded, and a pinching voltage of 0.94 kV was applied to each of the electrodes in the buffer reservoirs 15, 17. In the separation phase, a voltage of 5.40 kV was applied to the buffer supply reservoir 15, the buffer waste reservoir 17 was grounded, and a back voltage of 4.32 kV was applied to each of the electrodes in the sample reservoirs 8, 11.

Run A2

As for Run A1, but with an injection time of 40 s.

The results of the measurements for Runs A1 and A2 are given in Table 1, with the electropherogram obtained from Run A2 being illustrated in FIG. 5(a).

As will be noted, the sample length, and thus the sensitivity and column efficiency, are independent of injection time. This is as for conventional cross injectors.

Run B1

A sample plug was injected into another of the separation channels 5 and the analytes therein separated in the separation channel 5. In the injection phase, the injection time was 15 s, and a voltage of 1.08 kV was applied to the electrode in the sample reservoir 8, the electrode in the sample waste reservoir 11 was grounded, and the electrodes in the buffer reservoirs 15, 17 were floating. In the separation phase, a voltage of 5.40 kV was applied to the buffer supply reservoir 15, the buffer waste reservoir 17 was grounded, and a back voltage of 4.32 kV was applied to each of the electrodes in the sample reservoirs 8, 11.

Run B2

As for Run B1, but with an injection time of 20 s.

The results of the measurements for Runs B1 and B2 are given in Table 1, with the electropherogram obtained from Run B2 being illustrated in FIG. 5(b). The electropherogram includes peaks for fluorescein (F), FITC (Fc) and degradation products of FITC (Fcd1, Fcd2, Fcd3).

With this injection scheme, much sharper and higher peaks were achieved, both as compared to the pinched injection scheme of Runs A1 and A2 and also a conventional cross injector operated under the same injection scheme. As will be understood, the increase in the sharpness of the peaks provides for higher separation efficiency and the increase in the intensity of the peaks provides for higher sensitivity. The higher separation efficiency and sensitivity result at least in part from the shorter and more concentrated sample plugs. Furthermore, for the same cross injector configuration of the present invention, that is, comparing Runs B1 and B2 to Runs A1 and A2, the floating injection scheme, which is a simpler injection scheme than the pinched injection scheme, actually provides higher sensitivity than the pinched injection scheme, without compromising resolution. Moreover, despite the fact that the sample plug length achieved by the floating injection scheme in Run B2 was more than three times the sample plug length of the sample plug achieved by the pinched injection scheme in Run A1, the resolution was improved. In theory, when the sample plug length is shorter than the threshold, its contribution to the plate height should be negligible [12]. These results demonstrate that sufficiently well-shaped sample plugs can be obtained by the cross injector configuration of the present invention without employing the pinched injection scheme. With the cross injector configuration of the present invention, spreading of the sample plug is contained by the geometry of the cross injector. Thus, in marked contrast to conventional cross injectors, the cross injector configuration of the present invention provides improved performance when operated with the floating injection scheme as compared to the pinched injection scheme.

Run C1

A sample plug was injected into a further separation channel 5 and the analytes therein separated in the separation channel 5. In the injection phase, the injection time was 0.5 s, and a voltage of 1.08 kV was applied to the electrode in the sample reservoir 8, the electrode in the sample waste reservoir 11 was grounded, and the electrodes in the buffer reservoirs 15, 17 were floating. In the separation phase, a voltage of 5.40 kV was applied to the buffer supply reservoir 15, the buffer waste reservoir 17 was grounded, and the electrodes in the sample reservoirs 8, 11 were floating.

Run C2

As for Run C1, but with an injection time of 2 s.

Run C3

As for Run C1, but with an injection time of 3 s.

The results of the measurements for Runs C1, C2, C3 are given in Table 1, with the electropherogram obtained from Run C1 being illustrated in FIG. 5(c). The electropherogram includes peaks for fluorescein (F), FITC (Fc) and degradation products of FITC (Fcd1, Fcd2, Fcd3).

As will be noted, the cross injector configuration of the present invention provides a yet still higher separation efficiency when operated under the simple injection scheme as compared to the floating injection scheme. This improved separation efficiency arises as a result of the shorter injection time required when operating under the simple injection scheme, thereby suppressing the diffusion of the sample during injection. As will be appreciated, the sensitivity increases with the injection time, while the resolution decreases in both the simple and floating injection schemes. For a given peak height, that is, sensitivity, the simple injection scheme yields the best separation. Furthermore, baseline elevation, which is commonly observed in conventional cross injector configurations owing to severe leakage [18], is not observed in the cross injector configurations of the present invention. From a fluorescence image of the injection intersection taken in the separation phase, the analyte flows in the narrow sample channels 9, 13 were observed to withdraw automatically towards the respective sample reservoirs 8, 11, which were left floating.

In summary, the cross injector configuration of the present invention, when operated under the simple injection scheme, provides for an increase in sensitivity by a factor of 10, and more than a doubling of the separation efficiency, as compared to conventional cross injector configurations when operated under the pinched injection scheme. Moreover, these substantial improvements are achieved without any added complexity in the channel structure, and utilizing the simpler injection schemes. In fact, the cross injector configurations of the present invention require no voltage control to prevent leakage. In the prior art, a six-port injection structure has been proposed in order to achieve a sample plug of narrower width than the width of the separation channel [26], rendering the channel structure and the injection scheme much more complicated. The cross injector configuration of the present invention provides a much simpler and elegant solution.

FIG. 6 illustrates a CE measurement system in accordance with a second embodiment of the present invention.

The measurement system comprises a CE microchip 1 which includes at least one separation unit 3, in this embodiment a plurality of multiplexed separation units 3 disposed in parallel relation. For the purposes of exemplification, the microchip 1 is illustrated as including eight separation units 3, but could comprise any number of separation units 3, from one to many hundreds.

Each separation unit 3 includes a separation channel 5, in this embodiment an elongate linear channel having a length of 33 mm, a width of 50 μm and a depth of 10 μm, one end 6 of which provides an inlet through which a buffer medium is introduced and the other end 7 of which provides an outlet through which the buffer medium is exhausted. In operation, a sample plug is injected into the separation channel 5 and the analytes in the sample plug are separated during migration through the separation channel 5, as will be described in more detail hereinbelow.

Each separation unit 3 further includes a sample reservoir 8, in this embodiment a cavity having a diameter of 1 mm, into which a volume of a sample liquid is introduced, and a sample channel 9, in this embodiment having a length of 9 mm, a width of 5 μm and a depth of 10 μm, which fluidly connects the sample reservoir 8 to the separation channel 5. In this embodiment the sample channel 9 intersects the separation channel 5 in a direction perpendicular thereto, such that the separation channel 5 and the sample channel 9 define a tee injector. In this embodiment the sample channel 9 intersects the separation channel 5 at a distance of 3 mm from the inlet end 6 thereof and 30 mm from the outlet end 7 thereof.

The microchip 1 further comprises a common buffer supply reservoir 15 which is commonly connected to the inlet ends 6 of the separation channels 5 of each of the separation units 3, and a common buffer waste reservoir 17 which is commonly connected to the outlet ends 7 of the separation channels 5 of each of the separation units 3. In this embodiment the buffer reservoirs 15, 17 each have a length of 35 mm and a width of 7 mm.

The microchip 1 is fabricated from two planar plates, in this embodiment a plain glass substrate having a thickness of 1.5 mm and a poly (dimethylsiloxane) (PDMS) layer having a thickness about 0.3 to 0.4 mm. The fabrication of the PDMS layer, which defines the channels 5, 9 and the reservoirs 8, 15, 17 of the microchip 1, was performed in a number steps. In a first step, the chip layout was transferred onto a glass wafer having a coating of positive photoresist and chromium (Nanofilm, Westlake Village, Calif., US). In a second step, the chromium was etched to provide a chromium mask defining the chip layout. In a third step, a plain glass wafer was spin-coated with a negative photoresist (XP SU-8 10, MicroChem Corporation, Newton, Mass., US) at 2000 to 3000 rpm to provide an SU-8 master mask; the spinning speed determining the thickness of the coating, and hence the depth of the wells which define the separation channels 5 and the sample channels 9. In a fourth step, the transparent pattern on the chromium mask was then transferred to the master mask by disposing the chromium mask on the master mask and exposing the master mask using a collimated light beam, in this embodiment from a mercury lamp. In a fifth step, the unexposed SU-8 was flushed from the master mask with an SU-8 developer, leaving the SU-8 structures on the surface of the master mask. In a sixth step, PDMS base and curing agents (Sylgard 184, Dow Corning, Wiesbaden, Germany) were mixed in a 10:1 ratio and poured onto the master mask, and the resulting PDMS layer cured at 40° C. In a seventh step, large slots were cut into the PDMS layer at the respective ends of the wells defining the separation channels 5 to form openings which define the buffer reservoirs 15, 17. In an eighth step, eight holes were bored into the PDMS layer so as to provide openings which define the sample reservoirs 8. In a final step, the PDMS layer and the glass substrate were assembled to form the microchip 1.

The measurement system further comprises a confocal detection unit for detecting the optical emission, in this embodiment the fluorescence emission, from a detection region, in this embodiment a 50 μm×50 μm detection region, located, in this embodiment 28 mm, downstream of the injection intersection in the separation channel 5 of each of the separation units 3. In this embodiment the detection unit is a scanning unit which scans a detection window overlying the detection regions in the separation channels 5. In this embodiment the microchip 1 is disposed on a computer-controlled translation stage, whereby scanning is achieved by translating the microchip 1.

The detection unit comprises an objective 19 for imaging respective ones of the detection regions, a light source 21, in this embodiment a 50 W mercury lamp (Leica, Milton Keynes, UK), for providing a light beam for illuminating respective ones of the detection regions, and a dichroic beam splitter 23 (RKP 510) for directing the light beam from the light source 21 to the objective 19 and providing for the transmission of the optical emission from the respective detection region.

The detection unit further comprises an optical detector 25, in this embodiment a photomultiplier tube (MEA 153, Seefelder Messtechnik, Seefelder, Germany), for detecting the optical emission from the respective ones of the detection regions, in this embodiment the fluorescence emission, and at least one filter 27, in this embodiment two band pass filters (BP 450-490 nm, 515-560 nm), disposed upstream of the optical detector 25. In an alternative embodiment the optical detector 25 could comprise a CCD color camera (Sony Corporation, Japan).

The measurement system further comprises a data acquisition unit 31 which is connected to the optical detector 25 for logging the output signal thereof.

The measurement system further comprises a power supply unit 33 for applying potentials at the electrodes in each of the sample reservoirs 8, the buffer reservoir 15 and the buffer waste reservoir 17. For ease of illustration, FIG. 6 illustrates the power supply unit 33 connected to the sample reservoir 8 of only one of the separation units 3. In this embodiment each electrode is connected to two power supplies (F.u.G. Elektronik GmbH, Roseheim, Germany) and one ground line through relays, thereby enabling two different voltages and ground potential to be applied to each electrode in any run. In this embodiment the electrodes in the buffer reservoirs 15, 17 comprise elongate, linear platinum wire electrodes. Platinum wire electrodes are utilized to minimize the generation of air bubbles by electrolysis at the surface of the electrodes [25]. Electrolysis at the electrode surfaces is particularly evident in multiplexed systems as the current is many times higher than in single-channel systems. The use of long linear electrodes also has the particular advantage of ensuring that the potential is the same at the same length points for each of the separation channels 5.

The measurement system further comprises a processing unit 35, in this embodiment a personal computer, for controlling the power supply unit 33 and operating on the acquired data. In this embodiment the data acquisition unit 31 and the power supply unit 33 are operated under the control of a Labview program (Version 5.0, National Instruments, Austin, Tex., US), with data being acquired at a rate of 50 points/s.

Operation of the above-described measurement system of the present invention will now be described with reference to the following non-limiting Example.

Reagents and Solutions

A running buffer solution was prepared from 50 mM each of Tris (hydroxymethyl) aminomethane (Tris) (Lancaster Synthesis, Morecambe, UK) and N-tris (hydroxymethyl) methyl-3-aminopropanesulfonic acid (TAPS) (Merck, Leics, UK) (pH 8.8).

A sample solution containing 1 μg/mL fluorescein and 5 μg/mL fluorescein-5-isothiocyanate was prepared from fluorescein (Fluka, Buchs, Germany) and fluorescein-5-isothiocyanate (FITC) (Merck, Darmstadt, Germany) with the running buffer solution.

Experimental

The microchip 1 was first filled with ethanol by filling the buffer supply reservoir 15 and allowing the separation channels 5 and the sample channels 9 to fill by capillary action. The buffer reservoirs 15, 17 were then each flushed with de-ionized water and loaded with 1.5 mL of buffer solution. An electric field was then applied between the buffer reservoirs 15, 17 to fill the separation channels 5 by electroosmotic flow. The separation units 3 were then ready for CE separation.

In ones of the separation units 3, 3 μL aliquots of sample solution were introduced, in this embodiment by pipetting, into the respective ones of the sample reservoirs 8. CE separation runs (Run D) utilizing the simple injection scheme were then performed.

Results

The results of the measurements are given in Table 2 hereinbelow.

TABLE 2
Injection Schemes for Tee Injector Configurations

| Tee | | tᵢₙⱼ | | W_{1/2}^{c} | N^{c} | | Hₚₗₐₜₑ^{c} |
|---|---|---|---|---|---|---|---|
| Injector | Injection Run | (s) | S/N^{a} | (μm) | (k) | R^{d} | (μm) |
| Inventive | Run D1 (Simple) | 5 | 68 | 931 | 5.01 | 1.53 | 5.59 |
| | Run D2 (Simple) | 6 | 88 | 1030 | 4.09 | 1.47 | 6.84 |
| | Run D3 (Simple) | 7 | 116 | 1230 | 2.87 | 1.20 | 9.75 |

^{a}The signal-to-noise ratio as calculated based on the peak height of 1 μg/mL fluorescein.
^{b}The injected sample plug length (Lᵢₙⱼ) was measured by eye-checking the fluorescence images around the injection intersection with a sample solution containing 5 μg/mL fluorescein.
^{c}The peak width at half peak height (W_{1/2}), theoretical plate number (N) and plate height (Hₚₗₐₜₑ) are for FITC.
^{d}R is the resolution between FITC and fluorescein.

Run D1

A sample plug was injected into a first separation channel 5 and the analytes therein separated in the separation channel 5. In the injection phase, the injection time was 5 s, and a voltage of 1.08 kV was applied to the electrode in the sample reservoir 8, the buffer supply reservoir 15 was grounded, and the buffer waste reservoir 17 was floating. In the separation phase, a voltage of 5.40 kV was applied to the buffer supply reservoir 15, the buffer waste reservoir 17 was grounded, and the electrode in the sample reservoir 8 was floating.

Run D2

As for Run D1, but with an injection time of 6 s.

Run D3

As for Run D1, but with an injection time of 7 s.

The results of the measurements for Runs D1, D2, D3 are given in Table 2, with the electropherograms obtained from Runs D1, D2, D3 being illustrated in FIGS. 9(a) to (c). The electropherogram includes peaks for fluorescein (F), FITC (Fc) and degradation products of FITC (Fcd1, Fcd2, Fcd3).

As will be noted, the sample plug length, peak height and resolution are dependent on the injection time. Significantly, however, the tee injector configuration of the present invention provides a microchip which provides for the resolution of analytes of sample plugs, has a dramatically reduced number of reservoirs and requires no voltage control to prevent leakage.

Finally, it will be understood that the present invention has been described in its preferred embodiments and can be modified in many different ways without departing from the scope of the invention as defined by the appended claims.

### REFERENCES

[1] Ramseier, A.; von Heeren, F.; Thormann, W.; Electrophoresis 1998, 19, 2967.
[2] von Heeren, F.; Verpoorte, E.; Manz, A.; Thormann, W.; Anal. Chem. 1996, 68, 2044.
[3] Zhang, B.; Foret, F.; Karger, B. L.; Anal. Chem. 2000, 72, 1015.
[4] Effenhauser, C. S.; Manz, A.; Widmer, H. M.; Anal. Chem. 1995, 67, 2284.
[5] Liu, Y.; Foote, R. S.; Jacobson, S. C.; Ramsey, R. S.; Ramsey, J. M.; Anal. Chem. 2000, 72, 4608.
[6] Shi, Y.; Simpson, P. C.; Scherer, J. R.; Wexler, D.; Skibola, C.; Smith, M. T.; Mathies, R. A.; Anal. Chem. 1999, 71, 5354.
[7] Manz, A.; Harrison, D. J.; Verpoorte, E. M. J.; Fettinger, J. C.; Paulus, A.; Lüdi, H.; Widmer, H. M.; J. Chromatogr. 1992, 593, 253.
[8] Harrison, D. J.; Manz, A.; Fan, Z.; Lüdi, H.; Widmer, H. M.; Anal. Chem. 1992, 64, 1926.
[9] Liang, Z.; Chiem, N.; Ocvirk, G.; Tang. T.; Fluri, K.; Harrison, D. J.; Anal. Chem. 1996, 68, 1040.
[10] Harrison, D. J.; Fluri, K.; Seiler, K.; Fan, Z.; Effenhauser, C. S.; Manz, A.; Science 1993, 261, 895.
[11] Effenhauser, C. S.; Manz, A.; Widmer, H. M.; Anal. Chem. 1993, 65, 2637.
[12] Jacobson, S. C.; Hergenröder, R.; Koutny, L. B.; Warmack, R. J.; Ramsey, J. M.; Anal. Chem. 1994, 66, 1107.
[13] Effenhauser, C. S.; Paulus, A.; Manz, A.; Widmer, H. M.; Anal. Chem. 1994, 66, 2949.
[14] von Heeren, F.; Verpoorte, E.; Manz, A.; Thormann, W.; J. Microcolumn Sep. 1996, 8, 373.
[15] Hutt, L. D.; Glavin, D. P.; Bada, J. L.; Mathies, R. A.; Anal. Chem. 1999, 71, 4000.
[16] Liu, S.; Shi, Y.; Ja, W. W.; Mathies, R. A.; Anal. Chem. 1999, 71, 566.
[17] Cheng, J.; Waters, L. C.; Fortina, P.; Hvichia, G.; Jacobson, S. C.; Ramsey, J. M.; Kricka, L. J.; Wilding, P.; Anal. Biochem. 1998, 257, 101.
[18] Ocvirk, G.; Munroe, M.; Tang, T.; Oleschuk, R.; Westra, K.; Harrison, D. J.; Electrophoresis 2000, 21, 107.
[19] Wallenborg, S. R.; Bailey, C. G.; Anal. Chem. 2000, 72, 1872.
[20] Hashimoto, M.; Tsukagoshi, K.; Nakajima, R.; Kondo, K.; Arai, A.; J. Chromatogr, A 2000, 867, 271.
[21] Jacobson, S. C.; Koutny, L. B.; Hergenröder, R.; Moore, A. M., Jr.; Ramsey, J. M.; Anal. Chem. 1994, 66, 3472.
[22] Kutter, J. P.; Jacobson, S. C.; Matsubara, N.; Ramsey, J. M.; Anal. Chem. 1998, 70, 3291.
[23] Hadd, A. G.; Jacobson, S. C.; Ramsey, J. M.; Anal. Chem. 1999, 71, 5206.
[24] Woolley, A. T.; Sensabaugh, G. F.; Mathies, R. A.; Anal. Chem. 1997, 69, 2181.
[25] Zhu, T.; Sun, Y.-L.; Zhang, C.-X.; Sun, Z.-P.; Ling, D.-K.; J. High Resolut. Chromatogr. 1994, 17, 563.
[26] Deshpande, M.; Greiner, K. B.; West, J.; Gilbert, J. R.; Bousse, L.; Minalla, A.; In Proceedings of the Micro Total Analysis System 2000 Symposium, van den Berg, A., Olthuis, W., Bergveld, P., Eds.; Kluwer Academic Publishers: Dordrecht, The Netherlands, 2000, 339.

The contents of the above-mentioned references are incorporated herein by reference.

1. A capillary electrophoresis microchip including at least one capillary electrophoresis separation unit, each separation unit comprising:
a separation channel in which analytes of a sample plug are in use separated, wherein the separation channel has a first width; and
a sample channel fluidly connected to the separation channel through which a sample plug is in use introduced into the separation channel, wherein the sample channel has a second width which is smaller than the first width of the separation channel at least at intersection of the sample channel and the separation channel.

2. The microchip of claim 1, wherein the ratio of the first width to the second width is at least about 2:1.

3. The microchip of claim 2, wherein the ratio of the first width to the second width is at least about 5:1.

4. The microchip of claim 3, wherein the ratio of the first width to the second width is at least about 10:1.

5. The microchip of claim 1, wherein the second width is not more than about 10 μm.

6. The microchip of claim 5, wherein the second width is not more than about 5 μm.

7. The microchip of claim 1, wherein the separation channel and the sample channel have the same depth.

8. The microchip of claim 1, wherein the sample channel intersects the separation channel in a direction substantially perpendicular to the separation channel.

9. The microchip of claim 1, wherein the sample channel comprises a single sample inlet channel fluidly connected to the separation channel, whereby the separation channel and the sample inlet channel define a tee injector.

10. The microchip of claim 1, wherein the sample channel comprises a sample inlet channel fluidly connected to one side of the separation channel and a sample outlet channel fluidly connected to the other side of the separation channel, whereby the separation channel and sample channels define a cross injector.

11. The microchip of claim 10, wherein the sample inlet channel and the sample outlet channel are disposed in opposed relation.

12. The microchip of claim 1, comprising a plurality of separation units.

13. The microchip of claim 12, further comprising:
a buffer supply reservoir to which inlet ends of the separation channels of the separation units are commonly connected; and
a buffer waste reservoir to which outlet ends of the separation channels of the separation units are commonly connected.

14. A capillary electrophoresis measurement system incorporating the microchip of claim 1.

15. A method of separating analytes of a sample plug, comprising the steps of:
providing a capillary electrophoresis microchip including at least one capillary electrophoresis separation unit, wherein each separation unit comprises a separation channel having a first width, one end of which provides an inlet through which a buffer medium is introduced and the other end of which provides an outlet through which a buffer medium is exhausted, a sample reservoir containing a sample, and a sample channel fluidly connecting the sample reservoir and the separation channel through which a sample plug is introduced into the separation channel, the sample channel having a second width which is smaller than the first width of the separation channel at least at intersection of the sample channel and the separation channel;
injecting a sample plug into the separation channel by employing a first voltage protocol; and
separating analytes of the sample plug in the separation channel by employing a second voltage protocol.

16. The method of claim 15, wherein the step of injecting a sample plug into the separation channel comprises the step of applying only a single injection voltage.

17. The method of claim 16, wherein the single injection voltage is applied to the sample reservoir.

18. The method of claim 15, wherein the step of separating analytes of the sample plug in the separation channel comprises the step of applying only a single separation voltage.

19. The method of claim 18, wherein the single separation voltage is applied to the inlet end of the separation channel.

20. The method of claim 15, wherein the sample channel comprises a single sample channel fluidly connected to the separation channel, whereby the separation channel and the sample channel define a tee injector.

21. The method of claim 20, where the step of injecting a sample plug into the separation channel comprises the step of applying a potential between the sample reservoir and the inlet end of the separation channel, and leaving the outlet end of the separation channel floating.

22. The method of claim 20, wherein the step of injecting a sample plug into the separation channel comprises the step of applying only a single injection voltage to the sample reservoir.

23. The method of claim 20, wherein the step of injecting a sample plug into the separation channel comprises the step of applying only a single injection voltage to the inlet end of the separation channel.

24. The method of claim 20, wherein the step of injecting a sample plug into the separation channel comprises the step of applying an injection voltage to the sample reservoir, grounding the inlet end of the separation channel, and leaving the outlet end of the separation channel floating.

25. The method of claim 20, wherein the step of injecting a sample plug into the separation channel comprises the step of applying an injection voltage to the inlet end of the separation channel, grounding the sample reservoir, and leaving the outlet end of the separation channel floating.

26. The method of claim 20, wherein the step of separating analytes of the sample plug in the separation channel comprises the step of applying a potential between the inlet and outlet ends of the separation channel, and leaving the sample reservoir floating.

27. The method of claim 20, wherein the step of separating analytes of the sample plug in the separation channel comprises the step of applying only a single separation voltage to the inlet end of the separation channel.

28. The method of claim 20, wherein the step of separating analytes of the sample plug in the separation channel comprises the step of applying only a single separation voltage to the outlet end of the separation channel.

29. The method of claim 20, wherein the step of separating analytes of the sample plug in the separation channel comprises the step of applying a separation voltage to the inlet end of the separation channel, grounding the outlet end of the separation channel, and leaving the sample reservoir floating.

30. The method of claim 20, wherein the step of separating analytes of the sample plug in the separation channel comprises the step of applying a separation voltage to the outlet end of the separation channel, grounding the inlet end of the separation channel, and leaving the sample reservoir floating.

31. The method of claim 15, wherein the sample channel comprises a sample inlet channel fluidly connected to the sample reservoir and one side of the separation channel and a sample outlet channel fluidly connected to the other side of the separation channel, whereby the separation channel and the sample channels define a cross injector, and each separation unit further comprises a sample waste reservoir fluidly connected to the sample outlet channel.

32. The method of claim 31, wherein the sample inlet channel and the sample outlet channel are disposed in opposed relation.

33. The method of claim 31 or 32, wherein the step of injecting a sample plug into the separation channel comprises the step of applying a potential between the sample reservoir and the sample waste reservoir, and leaving the inlet and outlet ends of the separation channel floating.

34. The method of claim 31, wherein the step of injecting a sample plug into the separation channel comprises the step of applying only a single injection voltage to the sample reservoir.

35. The method of claim 31, wherein the step of injecting a sample plug into the separation channel comprises the step of applying only a single injection voltage to the sample waste reservoir.

36. The method of claim 31, wherein the step of injecting a sample plug into the separation channel comprises the step of applying an injection voltage to the sample reservoir, grounding the sample waste reservoir, and leaving the inlet and outlet ends of the separation channel floating.

37. The method of claim 31, wherein the step of injecting a sample plug into the separation channel comprises the step of applying an injection voltage to the sample waste reservoir, grounding the sample reservoir, and leaving the inlet and outlet ends of the separation channel floating.

38. The method of claim 31, wherein the step of separating analytes of the sample plug in the separation channel comprises the step of applying a potential between the inlet and outlet ends of the separation channel, and leaving the sample reservoir and the sample waste reservoir floating.

39. The method of claim 31, wherein the step of separating analytes of the sample plug in the separation channel comprises the step of applying only a single separation voltage to the inlet end of the separation channel.

40. The method of claim 31, wherein the step of separating analytes of the sample plug in the separation channel comprises the step of applying only a single separation voltage to the outlet end of the separation channel.

41. The method of claim 31, wherein the step of separating analytes of the sample plug in the separation channel comprises the step of applying a separation voltage to the inlet end of the separation channel, grounding the outlet end of the separation channel, and leaving the sample reservoir and sample waste reservoir floating.

42. The method of claim 31, wherein the step of separating analytes of the sample plug in the separation channel comprises the step of applying a separation voltage to the outlet end of the separation channel, grounding the inlet end of the separation channel, and leaving the sample reservoir and sample waste reservoir floating.

43. The method of claim 15, wherein the ratio of the first width to the second width is at least about 2:1.

44. The method of claim 43, wherein the ratio of the first width to the second width is at least about 5:1.

45. The method of claim 44, wherein the ratio of the first width to the second width is at least about 10:1.

46. The method of claim 15, wherein the second width is not more than about 10 μm.

47. The method of claim 46, wherein the second width is not more than about 5 μm.

48. The method of claim 15, wherein the separation channel and the sample channel have the same depth.

49. The method of claim 15, wherein the sample channel intersects the separation channel in a direction substantially perpendicular to the separation channel.

50. The method of claim 15, wherein the microchip comprises a plurality of separation units, whereby the method provides for the simultaneous measurement of a plurality of sample plugs.

51. The method of claim 50, wherein the microchip further comprises a buffer supply reservoir to which inlet ends of the separation channels of the separation units are commonly connected, and a buffer waste reservoir to which outlet ends of the separation channels of the separation units are commonly connected.
